(19) United States
(12) Patent Application Publication
(10) Pub. No.: US 2025/0271314 A1
(43) Pub. Date: Aug. 28, 2025

(54) SYSTEM AND METHOD FOR ELECTRIC MACHINE TORQUE ESTIMATION

(71) Applicant: Dana Belgium N.V., Brugge (BE)

(72) Inventors: Peter DECKMYN, Koekelare (BE); Tony LIBBRECHT, Waregem (BE); Kevin VYNCKE, Brugge (BE); Kris VANSTECHELMAN, Brugge (BE)

(21) Appl. No.: 19/002,397

(22) Filed: Dec. 26, 2024

Related U.S. Application Data
(60) Provisional application No. 63/557,955, filed on Feb. 26, 2024.

(51) Int. Cl. G01L 3/00; B60L 15/20

(52) U.S. Cl. CPC G01L 3/00; B60L 15/20; B60L 2240/12; B60L 2240/421; B60L 2240/423

(57) ABSTRACT

Methods and systems for estimating torque of an electric machine that propels a vehicle are described. The methods and systems may generate torque estimates that may be applied to higher and lower priority systems. In one example, a contactor may be selectively opened according to a torque estimate that is based on interpolating between two curves.

### CROSS REFERENCE TO RELATED APPLICATION

The present application claims priority to U.S. Provisional Application No. 63/557,955, entitled “SYSTEM AND METHOD FOR ELECTRIC MACHINE TORQUE ESTIMATION”, and filed on Feb. 26, 2024. The entire contents of the above-listed application are hereby incorporated by reference for all purposes.

### TECHNICAL FIELD

The present disclosure relates to a method and system for estimating torque of an electric machine. The electric machine may be a propulsion source for a vehicle.

### BACKGROUND AND SUMMARY

A torque generating system for an electric or hybrid vehicle may be comprised of an inverter or power converter and an electric machine. A controller for the torque generating system may provide an estimate of an amount of torque that is being generated by the torque source. However, the calculation of the torque signal that provides the estimated amount of torque that is being generated by the torque source may not be free from interference from other calculations done in the system and it may not provide compensation for inverter losses, such that the torque signal may not be suitable for tasks that rely on higher accuracy and higher priority. Therefore, it may be desirable to provide a way to generate an independent and reliable torque estimate that is simple to generate and that may depend on fewer parameters than other estimates. Further, it may be desirable to generate a torque estimate that has a lower propensity to degrade as compared to other torque estimates.

The inventors herein have recognized the above-mentioned issues and have developed a method for estimating torque output of an electric vehicle propulsion source, comprising: generating a first polynomial for a first group of speeds of the electric vehicle propulsion source, where output of the first polynomial provides a torque estimate for the electric vehicle propulsion source; generating a second polynomial for a second group of speeds of the electric vehicle propulsion source, where output of the second polynomial provides a torque estimate for the electric vehicle propulsion source; and operating a vehicle in response to the torque estimate for the electric vehicle propulsion source.

By generating polynomials to estimate torque output of a torque generating system, it may be possible to provide the technical result of generating an electric machine torque estimate that compensates for inverter losses and reduces system complexity. In particular, a first polynomial may be generated to approximate electric machine torque at lower electric machine speeds and a second polynomial may be generated to approximate electric machine torque at higher electric machine speeds. The polynomials may simplify electric machine torque estimation and improve torque estimation reliability.

The present description may provide several advantages. In particular, the approach may provide reliable torque estimation. In addition, the approach may simplify electric machine torque estimation to reduce processing time and enable higher priority systems to rely on the torque estimated.

It is to be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not restricted to implementations that solve any disadvantages noted above or in any part of this disclosure.

### BRIEF DESCRIPTION OF THE DRAWINGS

FIG. 1 is an illustration of an example vehicle that includes an electric machine that is configured to propel a vehicle.

FIG. 2 shows a flowchart of a method to generate curves for estimating torque output of a torque source.

FIG. 3 shows example plots representing data flow to generate curves for estimating torque output of a torque source.

FIG. 4 shows a plot of example drive and regeneration torques for an electric machine.

FIG. 5 shows a block diagram for embedded processing and data flow for estimating torque output of an electric machine.

FIG. 6 shows a plot that illustrates interpolation between two curves.

FIG. 7 shows a block diagram of integration of a method for estimating torque output of an electric machine into a vehicle.

### DETAILED DESCRIPTION

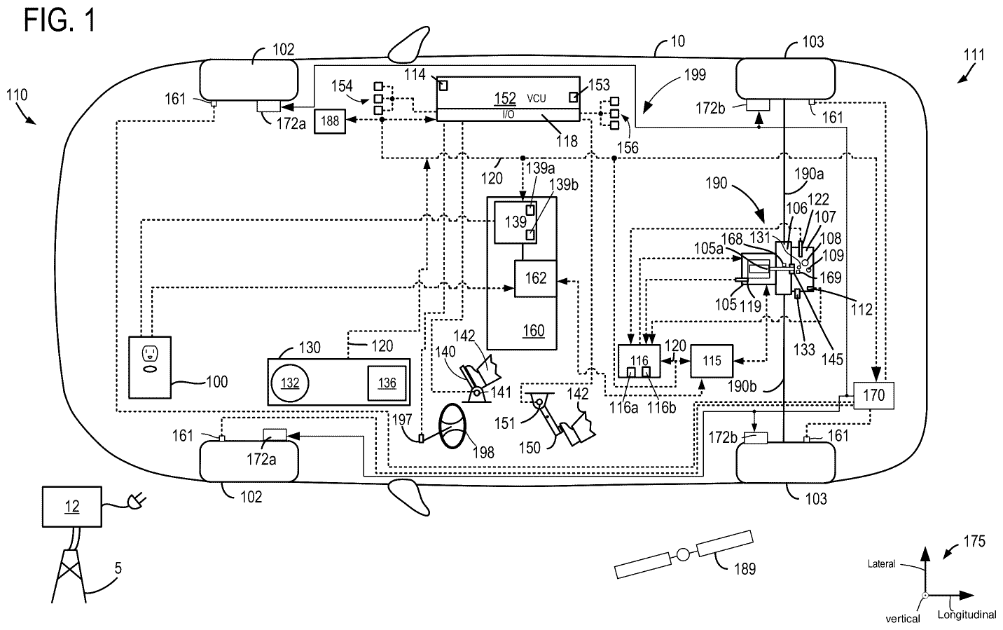

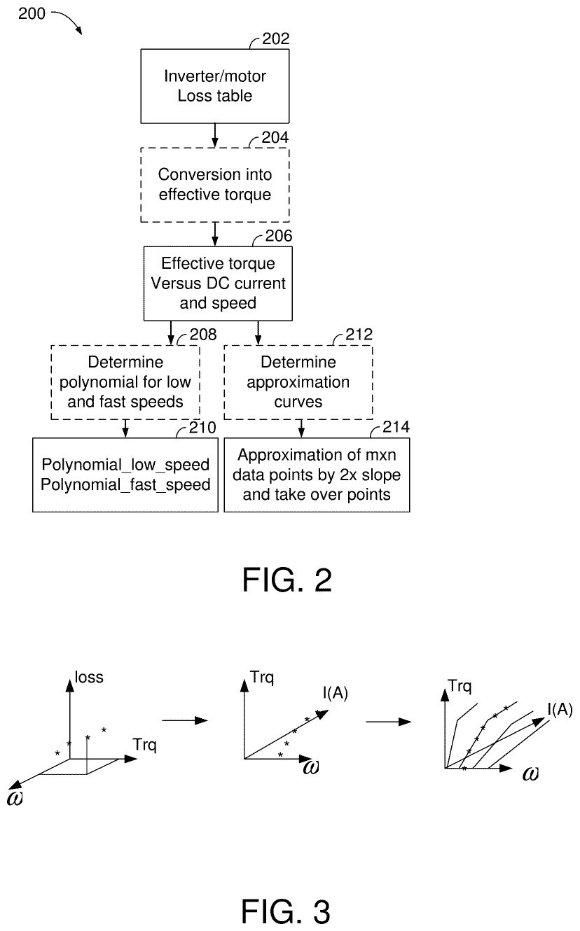

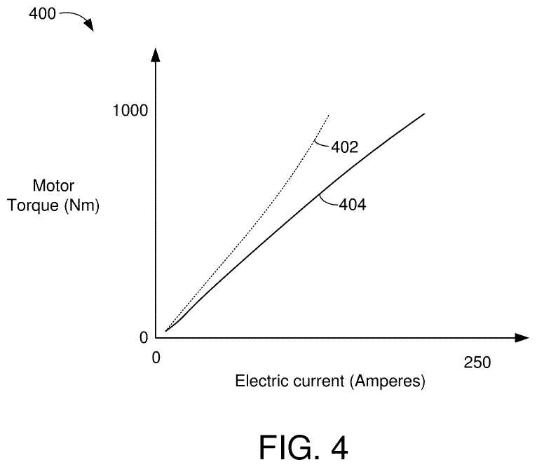

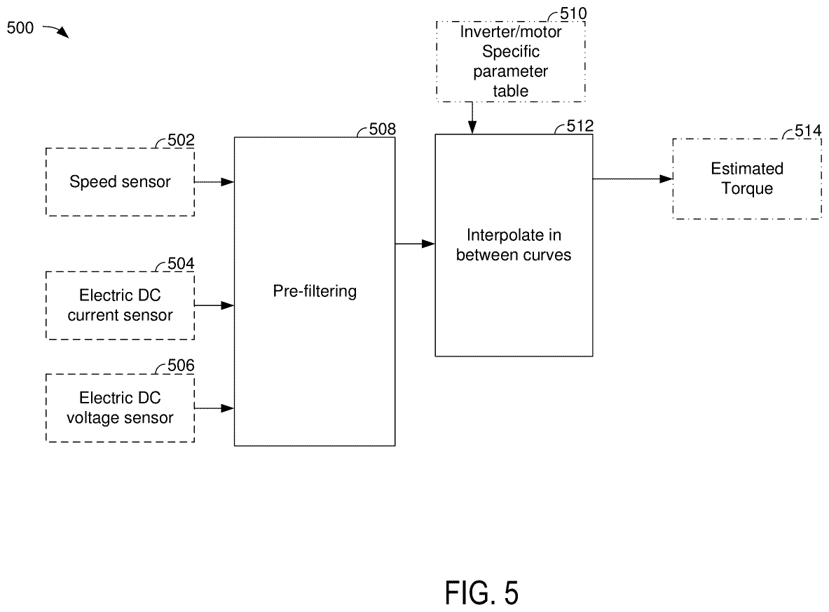

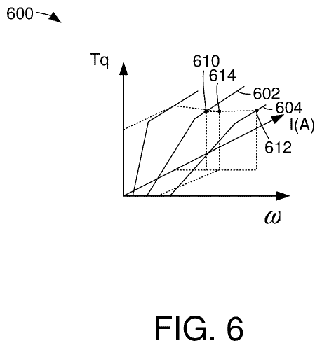

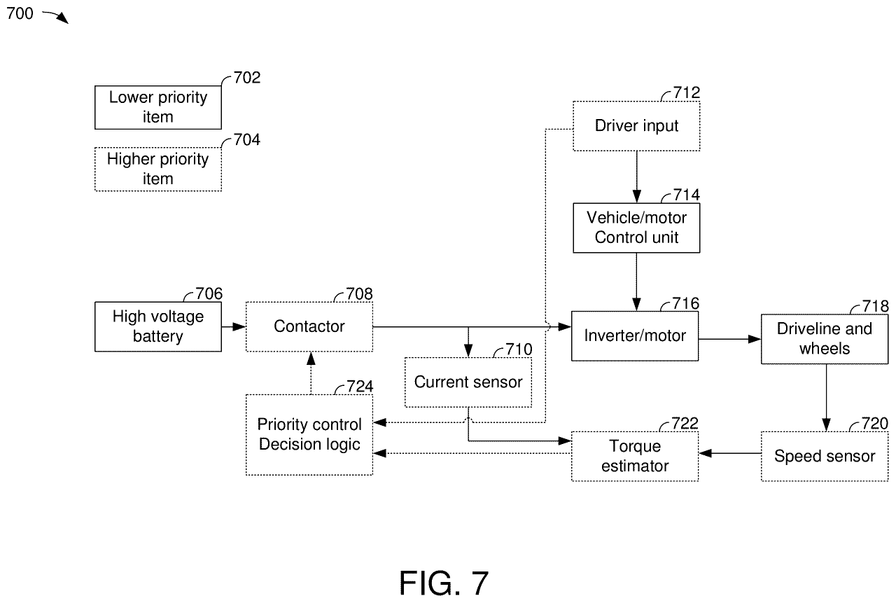

A method and system for estimating torque output of an electric machine of a vehicle are described. The method and system are suitable for electric drive systems as shown in FIG. 1 and hybrid vehicles. In one example, the method and system may generate a group of curves to approximate torque output of an electric machine as shown in the block diagram of FIG. 2. The flow of data to generate the torque estimate may be as shown in FIG. 3. Torque output for an electric machine may be as shown in the plot of FIG. 4. Data may be processed according to the block diagram of FIG. 5 to generate a torque estimate for an electric machine. Torque estimates may be based on interpolating between two curves as shown in FIG. 6. A system and method for estimating torque generated via an electric machine may be integrated into a vehicle as shown by the block diagram of FIG. 7.

FIG. 1 illustrates an example vehicle propulsion system 199 for vehicle 10. A front end 110 of vehicle 10 is indicated and a rear end 111 of vehicle 10 is also indicated. Vehicle 10 travels in a forward direction when front end leads movement of vehicle 10. Vehicle 10 travels in a reverse direction when rear end leads movement of vehicle 10. Vehicle propulsion system 199 includes a propulsion source 105 (e.g., an electric machine, such as a motor), but in other examples two or more propulsion sources may be provided. In one example, propulsion source 105 may be a synchronous or induction electric machine that may operate as a motor or generator. The propulsion source 105 is fastened to the electrified axle 190 and it delivers power from its rotor 105a to gear set 107. In FIG. 1 mechanical connections between the various components are illustrated as solid lines, whereas electrical connections between various components are illustrated as dashed lines.

Vehicle propulsion system 199 includes an electrified axle 190 (e.g., an axle that includes an integrated electric machine that provides propulsive effort for the vehicle). Electrified axle 190 may include two axle shafts, including a first or right axle shaft 190a and a second or left axle shaft 190b. Vehicle 10 further includes front wheels 102 and rear wheels 103.

The electrified axle 190 may be an integrated axle that includes differential gears 106, gear set 107, and propulsion source 105. Gear set 107 may be referred to as a step ratio transmission and it may include a plurality of gears and one or more clutches to shift between gears. In one example, the gear set may include a first gear 108, a second gear 109, and a third gear 131. Further, the electrified axle 190 may include one or more clutch actuators 112 to shift one or more clutches 145. Clutches 145 may be configured as dog clutches, wet, friction, curvic, or other known configuration. Encoder 168 provides an indication of motor position and a position of a half of clutch 145 (e.g., upstream power path side of clutch 145) and encoder 169 provides an indication of a clutch position of a downstream clutch power path side of clutch 145. Electrified axle 190 may include a first speed sensor 119 for sensing a speed of propulsion source 105 on an input side of clutch 145 and a second speed sensor 122 for sensing a speed of an output side of clutch 145. Electric power inverter 115 is electrically coupled to propulsion source 105. An axle control unit 116 is electrically coupled to sensors and actuators of electrified axle 190.

Propulsion source 105 may transfer mechanical power to or receive mechanical power from gear set 107. As such, gear set 107 may be a multi-speed gear set that may shift between gears (e.g., first gear 108 and second gear 109) when commanded via axle control unit 116. Axle control unit 116 includes a processor 116a and memory 116b. Memory 116b may include read only memory, random access memory, and keep alive memory. Axle control unit 116 may receive transmission temperature via sensor 133. Gear set 107 may transfer mechanical power to or receive mechanical power from differential gears 106. Differential gears 106 may transfer mechanical power to or receive mechanical power from rear wheels 103 via right axle shaft 190a and left axle shaft 190b. Propulsion source 105 may consume alternating current (AC) electrical power provided via electric power inverter 115. Alternatively, propulsion source 105 may provide AC electrical power to electric power inverter 115. Electric power inverter 115 may be provided with high voltage direct current (DC) power from battery 160 (e.g., a traction battery, which also may be referred to as an electric energy storage device or battery pack). Electric power inverter 115 may convert the DC electrical power from battery 160 into AC electrical power for propulsion source 105. Alternatively, electric power inverter 115 may be provided with AC power from propulsion source 105. Electric power inverter 115 may convert the AC electrical power from propulsion source 105 into DC power to store in battery 160.

Battery 160 may periodically receive electrical energy from a power source such as a stationary power grid 5 residing external to the vehicle (e.g., not part of the vehicle). As a non-restricted example, vehicle propulsion system 199 may be configured as a plug-in electric vehicle (EV), whereby electrical energy may be supplied to battery 160 via the power grid 5 and charging station 12. Electric charge may be delivered to battery 160 via plug receptacle 100.

Battery 160 may include a BMS controller 139 (e.g., a battery management system controller) and an electrical power distribution box 162. BMS controller 139 may provide charge balancing between energy storage elements (e.g., battery cells) and communication with other vehicle controllers (e.g., vehicle control unit 152). BMS controller 139 includes a core processor 139a and memory 139b (e.g., random-access memory, read-only memory, and keep-alive memory).

Vehicle 10 may include a vehicle control unit (VCU) 152 that may communicate with electric power inverter 115, axle control unit 116, friction or foundation caliper controller 170, global positioning system (GPS) 188, BMS controller 139, and dashboard 130 and components included therein via controller area network (CAN) 120. VCU 152 includes memory 114, which may include read-only memory (ROM or non-transitory memory) and random access memory (RAM). VCU also includes a digital processor or central processing unit (CPU) 153, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not restricted to lateral accelerometers, longitudinal accelerometers, yaw rate sensors, inclinometers, temperature sensors, battery voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and caliper pedal position sensor 151. Actuators may include but are not constrained to inverters, transmission controllers, display devices, human/machine interfaces, friction braking systems, and battery controller described herein.

Driver demand pedal position sensor 141 is shown coupled to driver demand pedal 140 for determining a degree of application of driver demand pedal 140 by human 142. Caliper pedal position sensor 151 is shown coupled to caliper pedal 150 for determining a degree of application of caliper pedal 150 by human 142. Steering angle sensor 197 is configured to determine a steering angle according to a position of steering wheel 198.

Vehicle propulsion system 199 is shown with a global position determining system 188 that receives timing and position data from one or more GPS satellites 189. Global positioning system may also include geographical maps in ROM for determining the position of vehicle 10 and features of roads that vehicle 10 may travel on.

Vehicle propulsion system 199 may also include a dashboard 130 that an operator of the vehicle may interact with. Dashboard 130 may include a display system 132 configured to display information to the vehicle operator. Display system 132 may comprise, as a non-restricting example, a touchscreen, or human machine interface (HMI), display which enables the vehicle operator to view graphical information as well as input commands. In some examples, display system 132 may be connected wirelessly to the internet (not shown) via VCU 152. As such, in some examples, the vehicle operator may communicate via display system 132 with an internet site or software application (app) and VCU 152.

Dashboard 130 may further include an operator interface 136 via which the vehicle operator may adjust the operating status of the vehicle. Specifically, the operator interface 136 may be configured to activate and/or deactivate operation of the vehicle driveline (e.g., propulsion source 105) based on an operator input. Further, an operator may request an axle mode (e.g., park, reverse, neutral, drive) via the operator interface. Various examples of the operator interface 136 may include interfaces that utilize a physical apparatus, such as a key, that may be inserted into the operator interface 136 to activate the electrified axle 190 and propulsion source 105 and to turn on the vehicle 10 or may be removed to shut down the electrified axle and propulsion source 105 to turn off vehicle 10. Electrified axle 190 and propulsion source 105 may be activated via supplying electric power to propulsion source 105 and/or electric power inverter 115. Electrified axle 190 and electric machine may be deactivated by ceasing to supply electric power to electrified axle 190 and propulsion source 105 and/or electric power inverter 115. Still other examples may additionally or optionally use a start/stop button that is manually pressed by the operator to start or shut down the electrified axle 190 and propulsion source 105 to turn the vehicle on or off. In other examples, a remote electrified axle or electric machine start may be initiated remote computing device (not shown), for example a cellular telephone, or smartphone-based system where a user's cellular telephone sends data to a server and the server communicates with the vehicle control unit 152 to activate the electrified axle 190 including an inverter and electric machine. Spatial orientation of vehicle 10 is indicated via axes 175.

Vehicle 10 is also shown with a foundation or friction caliper controller 170. Friction caliper controller 170 may selectively apply and release friction calipers (e.g., 172a and 172b) via allowing hydraulic fluid to flow to the friction calipers. The friction calipers may be applied and released so as to reduce a possibility of locking of the friction calipers to front wheels 102 and rear wheels 103. Wheel position or speed sensors 161 may provide wheel speed data to friction caliper controller 170. Vehicle propulsion system 199 may provide torque to rear wheels 103 to propel vehicle 10.

A human or autonomous driver may request a driver demand wheel torque, or alternatively a driver demand wheel power, via applying driver demand pedal 140 or via supplying a driver demand wheel torque/power request to vehicle control unit 152. Vehicle control unit 152 may then demand a torque or power from propulsion source 105 via commanding axle control unit 116. Axle control unit 116 may command electric power inverter 115 to deliver the driver demand wheel torque/power via electrified axle 190 and propulsion source 105. Electric power inverter 115 may convert DC electrical power from battery 160 into AC power and supply the AC power to propulsion source 105. Propulsion source 105 rotates and transfers torque/power to gear set 107. Gear set 107 may supply torque from propulsion source 105 to differential gears 106, and differential gears 106 transfer torque from propulsion source 105 to rear wheels 103 via axle shafts 190a and 190b.

During conditions when the driver demand pedal is fully released, vehicle control unit 152 may request a small negative or regenerative braking power to gradually slow vehicle 10 when a speed of vehicle 10 is greater than a threshold speed. The amount of regenerative braking power requested may be a function of driver demand pedal position, battery state of charge (SOC), vehicle speed, and other conditions. If the driver demand pedal 140 is fully released and vehicle speed is less than a threshold speed, vehicle control unit 152 may request a small amount of positive torque/power (e.g., propulsion torque) from propulsion source 105, which may be referred to as creep torque or power. The creep torque or power may allow vehicle 10 to remain stationary when vehicle 10 is on a small positive grade.

The human or autonomous driver may also request a negative or regenerative driver demand braking torque, or alternatively a driver demand braking power, via applying caliper pedal 150 or via supplying a driver demand braking power request to vehicle control unit 152. Vehicle control unit 152 may request that a first portion of the driver demanded braking power be generated via electrified axle 190 and propulsion source 105 via commanding axle control unit 116. Additionally, vehicle control unit 152 may request that a portion of the driver demanded braking power be provided via friction calipers 172 via commanding friction caliper controller 170 to provide a second portion of the driver requested braking power.

After vehicle control unit 152 determines the braking power request, vehicle control unit 152 may command axle control unit 116 to deliver the portion of the driver demand braking power allocated to electrified axle 190. Electric power inverter 115 may convert AC electrical power generated by propulsion source 105 into DC power for storage in battery 160. Propulsion source 105 may convert the vehicle's kinetic energy into AC power.

Axle control unit 116 includes predetermined transmission gear shift schedules whereby fixed ratio gears of gear set 107 may be selectively engaged and disengaged. Shift schedules stored in axle control unit 116 may select gear shift points or conditions as a function of driver demand wheel torque and vehicle speed.

The description herein is not limited to electric vehicles configured as shown in FIG. 1. Rather, the description is applicable to other electrified powertrains including parallel and series hybrid vehicles.

Thus, the system of FIG. 1 provides for a vehicle system, comprising: an electric energy storage device; an electric machine configured to propel a vehicle; an inverter configured to supply alternating current to the electric machine; a contactor arranged in series between the electric energy storage device and the inverter; and one or more controllers (e.g., controllers 152 and/or 116 of FIG. 1) including executable instructions stored in non-transitory memory that cause the controller to selectively open the contactor in response to an estimate of torque output of the electric machine, where the estimate of torque output is based on interpolating between two linear curves or interpolating between output of two polynomials. In a first example, the vehicle system includes where a first polynomial of the two polynomials corresponds to a first speed range of the electric machine. In a second example that may include the first example, the vehicle system includes where a second polynomial of the two polynomials corresponds to a second speed range of the electric machine, the second speed range greater than the first speed range. In a third example that may include one or both of the first and second examples, the vehicle system includes where the first polynomial receives electric machine speed and inverter input current as inputs. In a fourth example that may include one or more of the first through third examples, the vehicle system includes where a first curve of the two linear curves is based on a DC current flow into the inverter. In a fifth example that may include one or more of the first through fourth examples, the vehicle system includes where a second curve of the two linear curves is based on a take-over point. In a sixth example that may include one or more of the first through fifth examples, the vehicle system includes where the second curve is further based on DC current flow into the inverter.

Turning now to FIG. 2, a block diagram of a method 200 that describes determination of parameters for a torque estimation algorithm is shown. The method of FIG. 2 may operate in cooperation with the systems and other methods described herein. Further, the method of FIG. 2 may be incorporated as executable instructions that are stored in non-transitory memory of one or more controllers (e.g., controllers 152 and/or 116 of FIG. 1) that cause the controller to adjust states or positions of actuators in the physical world. The blocks (e.g., 204, 208, and 212) that are formed by dashed lines represent processing blocks where data may be processed and blocks that are formed by solid lines (e.g., 202, 206, 210, and 214) represent passive data blocks.

At 202, method 200 generates an inverter and motor loss table. In one example, the inverter and motor loss table is a two dimensional table that may be referenced by DC current that is input to the inverter and motor and motor speed. The table may have dimensions of N×M where N is the number of motor speed rows in the table and M is the number of motor torque command columns. Thus, the table includes N×M speed and torque combinations. Loss values in the table may be determined by subtracting measured motor power output from electric power that is input to the inverter and motor. Alternatively, a percentage loss value may be determined by dividing the motor output power by the inverter and motor input electric power. The losses determined at 202 are input to block 204.

At block 204, method 200 estimates an effective torque that is output by the motor. In one example, method 200 may estimate the effective torque from a second table that may be referenced by DC current that is input to the inverter and motor and motor speed. The second table may also have dimensions of N rows by M columns. The second table outputs an effective torque value and the effective torque value may include compensation for the loss value that was generated at 202. In particular, the effective torque generated by the electric machine may be determined via the equation: Trq_EFF=(V_DC*I_DC-losses)/ω, where Trq_EFF is the effective torque, V_DC is the input DC voltage to the inverter, I_DC is the input current to the inverter, losses are the inverter and electric machine losses, and ω is the rotational speed of the electric machine. The losses may be determined by an amount of power to yield a particular effective torque and may be determined via the following equations: input power=V_DC*I_DC=losses+mechanical power generated by the electric machine=losses+(ω*Trq_eff). The effective torque values at predetermined electric machine rotational speeds and predetermined DC current values that are input to the inverter that supplies power to the electric machine may be inserted into a data structure (e.g., a table or function) as shown in FIG. 3.

The effective torque value at present operating conditions may be estimated by converting the table mentioned at 202, which outputs the required DC current for particular electric machine speed and torque combinations into a table that outputs effective electric machine torque for particular electric machine speed and DC input current (e.g., DC current into the electric machine's associated inverter) combinations into a table that outputs effective electric machine torque according to electric machine speed and DC input current combinations. Method 200 proceeds to 206.

At 206, method 200 decides whether to process the table that outputs the effective torque value at block 204. The table may be processed via a first method or a second method. If the first method is selected, method 200 proceeds to 208. If the second method is selected, method 200 proceeds to 212. The first method may be selected based on whether or not the processor or controller has capacity to execute the polynomial calculation in real-time. In order to provide consistent and repeatable operation of devices and sub-systems, a controller may begin execution of certain controller executable instructions at fixed time intervals between the beginnings of executing the certain controller executable instructions (e.g., real-time time intervals). If the instructions to perform the first method are executable within a particular real-time interval/window and/or if the controller includes a floating point library or processor, method 200 may select the first method to execute. The second method may be chosen when a floating point library or processor are not present.

At 208, method 200 derives an approximation for the table of step 204 according to a best fit algorithm. The best fit algorithm minimizes both the total amount inaccuracy as well as the maximum level of inaccuracy in a configurable weighted manner. Method 200 approximates the actual torque via two polynomials, where actual torque=polynomial_low_speed=f_low (speed, current)=Σ_{i,j=0}ⁿaᵢⱼxⁱy^{j} for speed<low_speed_threshold, where actual torque=polynomial_high_speed=f_high(speed, current)=Σ_{i,j=0}ⁿaᵢⱼxⁱy^{j}+b*(y/x) for speed>low_speed_threshold. The variable speed is the motor speed and the variable current is DC current flowing to the inverter that supplies power to the motor. Further, x=speed, y=current, such that a set of aᵢⱼ and b parameters are constants of the polynomial that describes a three dimensional surface between electric machine effective torque, electric machine speed, and current flow inout the inverter that provides power to the electric machine. Practically, i=2 and y=4 gives a good fit for the low speed region. Additionally, i=3 and y=2 gives a good fit for the high speed region. The size of the required data set for the embedded processing is 2×i×j. The polynomials Polynomial_low_speed and Polynomial_high_speed are stored in controller memory at block 210 and the actual motor torque may be determined from the polynomials.

Additionally, method 200 may apply a motor data set that includes a maximum DC voltage input to the inverter so that applied torque may not be under estimated. Alternatively, the motor data set of an estimated average input DC voltage may be applied to generate an estimated torque that is on average more accurate for a full range of DC input voltages. In still other examples, different curves may be obtained for different DC voltage motor data to increase accuracy of motor torque estimates. Further, different data sets may be applied for estimating motoring and regeneration electric machine torques, where different polynomials or linear approximations may be provided for motoring and regeneration torques.

At 212, method 200 derives an approximation for the table of step 204 according to a second algorithm. The second method derives a reasonable approximation for the above table using a best fit algorithm. The second algorithm minimizes both the total amount inaccuracy of motor torque as well as the maximum level of inaccuracy of motor torque in a configurable weighted manner. The actual motor torque is approximated at a given motor speed by two linear approximations, where actual motor torque=a₁*motor current for motor current<take over point, actual motor torque=a₁*take-over point+a₂*(motor current-take over point) for motor current>take over point for a well-chosen set of motor speeds a₁, a₂, and take over point will be determined. The take-over point is a given value of DC current below which the torque increases with increasing current by a factor of a1; above which the torque increases with increasing current by a factor of a2. The variables a1 and a2 are defined as the factor of increase of torque versus an increase of current. For example, a1=5 Newton-meter (Nm)/ampere so an increase of 1 Amp DC current, leads to an increase of 5 Nm of torque. All three values a1, a2, and take-over point are obtained by applying a best fit algorithm to approach the surface Trq=f (I_DC, speed) for a particular electric machine speed. The size of the obtained data set for the embedded processing is typically 3×N, where N is the amount of motor speed set points, and where 3 is given by two slopes of the approximation curves and one take over point.

At 214, method 200 a best fit of the surface Trq=f (I_DC, speed) formed by a set of lines for different electric machine speeds is determined. All three values a1, a2, and take-over point are obtained by applying a best fit algorithm to approach the surface Trq=f (I_DC, speed) given a predetermined electric machine speed. The best fit is performed for the entire speed range so that an electric machine speed of 100 revolutions/minute (RPM) provides a triple (a1, a2, take-over point), an electric machine speed of 200 RPM provides another triple (a1, a2, take over point), etc.

Referring now to FIG. 3, plots illustrating flow of data to determine motor torque approximation curves are shown. The left most plot in FIG. 3 is a plot of motor data points and corresponding inverter and motor losses for the motor torque and motor rotational speed set points. The middle plot in FIG. 3 is a plot of data that may be stored in a table that may be referenced by motor rotational speed and DC (direct current) that is supplied to the inverter that supplies electric power to the motor (I(A)). The table is populated with motor torque estimates and outputs the motor torque estimates according to present motor rotational speed and DC current flow into the inverter. The right most plot in FIG. 3 is a plot showing curves that describe motor torque (Trq) as a function of motor rotational speed (ω) and DC current flow into the inverter (I(A)). The curves in the right most plot may be generated from the data in the table that is the basis for the center plot in FIG. 3. Plots similar to the plots in FIG. 3 may be generated for regeneration torque and motoring torque.

Referring now to FIG. 4, a plot that shows drive or motoring torque and regenerative torque versus electric machine current for a predetermined electric machine rotational speed are shown. The vertical axis represents electric machine torque and the horizontal axis represents electric machine current. Curve 404 represents motoring torque for an electric machine versus electric current for the electric machine. Curve 402 represents regeneration torque for an electric machine versus electric current for the electric machine. Since these curves are different, they may be approximated via different polynomials or different linear approximations.

Moving on to FIG. 5, a block diagram of a method 500 for embedded processing of electric machine data is shown. The method of FIG. 5 may operate in cooperation with the systems and other methods described herein. Further, the method of FIG. 5 may be incorporated as executable instructions that are stored in non-transitory memory of a controller that cause the controller to adjust states or positions of actuators in the physical world. The blocks that are formed by dashed lines (e.g., 502, 504, and 506) represent blocks where signals may be captured via a controller storing data values to controller memory. The blocks that are formed by solid lines (e.g., 508 and 512) represent data processing blocks. The block that is formed by dash-dot-dot a line (e.g., 510) represents a data table. The block that is formed by a dash-dot line (e.g., 514) represents an output block where data is output.

Method 500 includes an electric machine rotational speed sensor that is indicated at block 502. The rotational speed sensor may measure a speed of an electric machine rotor or a device that is coupled to the electric machine's rotor. A speed signal is generated by the speed sensor and the speed signal is provided to a pre-filtering block 508. Method 500 also includes a DC current sensor and the DC current sensor senses DC current that flows into and out of the inverter that is electrically coupled to the electric machine or propulsion source. An electric current signal is generated by the current sensor and the current signal is provided to the pre-filtering block 508. Method 500 also includes a DC voltage sensor and the DC voltage sensor senses a voltage that is input and output of the inverter that is electrically coupled to the electric machine. A voltage signal is generated by the voltage sensor and the voltage signal is input to the pre-filtering block 508.

Pre-filtering block 508 filters the electric machine speed, DC current, and DC voltage signals. In one example, method 500 may low pass filter the signals to reduce noise that may be included in the signals. The filtered electric machine speed, DC current, and DC voltage are provided to block 512 where method 500 interpolates between curves that describe a relationship between electric machine speed, DC current flow into or out of an inverter or power converter and the electric machine that provides propulsive effort to the vehicle, and torque output of the electric machine. The interpolation may be performed via processing block 522 applying values stored in data table 520 that have been determined via method 200. The values may represent polynomials or linear approximations of curves that describe electric machine torque output according to DC current and electric machine rotational speed as discussed with respect to method 200. The interpolation may be performed via a third method or a fourth method. The third method includes selecting an applicable polynomial based on electric machine rotational speed, applying the selected polynomial by plugging (e.g., inserting) the present electric machine speed and DC current flow into or out of the inverter that is coupled to the electric machine into the polynomial and generating the electric machine torque according to output of the selected polynomial. Optionally, the DC voltage that is input or output of the inverter may be plugged into the polynomial when the polynomial is based on DC voltage. On the other hand, the fourth method includes selecting two linear interpolation data sets that are closest to the present rotational speed of the electric machine, determine the electric machine torque according to each of the interpolation data sets according to the DC current flow into or out of the inverter, and interpolate between the two torques determined from the two interpolation data sets. Optionally, if DC voltage into or out of the inverter that is electrically coupled to the electric machine is available, different interpolation curves may be applied to estimate electric machine torque according to the DC voltage.

The estimated electric machine torque may be supplied output block 514 where the estimated electric machine torque may be made available throughout the system for use as a controller feedback signal or control signal. The estimated electric machine torque may be made available to electric machine control routines as indicated at block 514.

Referring now to FIG. 6, a plot showing an example of interpolation between two different curves to estimate torque output of an electric machine is shown. Plot 600 shows a first relationship between DC current (I(A)), electric machine rotational speed (ω), and electric machine torque (Trq) that is represented by curve 602. Plot 600 shows a second relationship between DC current (I(A)), electric machine rotational speed (ω), and electric machine torque (Trq) that is represented by curve 604. For estimating a torque of the electric machine that is generated at an electric machine speed that is in between the speed of curve 602 and curve 604, a method interpolates between a torque at the present DC current for curve 602 and torque at the present DC current for curve 604. In particular, the method subtracts the present speed of the electric machine from the electric machine speed represented by curve 602 and divides the result by the speed represented by curve 604 minus the speed represented by curve 602. The result of the division is multiplied by the torque represented by curve 604 (e.g., torque at dot 610) minus the torque represented by curve 602 (e.g., torque at dot 612). The result of the multiplication is added to the torque that is represented by curve 604 at the present DC current and electric machine speed to generate the interpolated torque value (e.g., torque at dot 614).

Finally, FIG. 7 shows a block diagram 700 of torque estimator that has been integrated into a vehicle. The methods of FIGS. 2 and 5 are represented by block 722 that is labeled “torque estimator.” The blocks that are shown in dashed lines may be hosted in a high priority controller (e.g., controllers 152 and/or 116 of FIG. 1). The high priority controller may be specifically rated to handle higher priority system tasks and calculations that may include but are not limited to automatic system shutdown and processing higher priority inputs.

Block diagram may include lower priority tasks and inputs/outputs that are represented by block 702 and higher priority tasks and inputs/outputs that are represented by block 704. A high voltage battery represented by block 706 may supply electric power and the supply of electric power may be controlled via selectively opening and closing contactor 708. Contactor 708 may be selectively opened and closed according to priority control decision logic that is represented by block 724. Electric current flow through contactor 708 may be monitored via current sensor 710 and supplied to the inverter and motor that is represented by block 716 (e.g., inverter 115 and electric machine 105 of FIG. 1). Human driver input that is represented by block 712 may be provided to priority control decision logic block 724 and a vehicle controller that is represented by block 714. The electric machine may provide propulsive effort to the vehicle driveline and wheels that are represented by block 718. Wheel speed and/or electric motor rotational speed may be sensed via a speed sensor that is represented by block 720 and the speed may be input to torque estimator block 722.

In one example, the priority control decision logic may open contactor 708 in response to torque estimates that are generated according to torque estimator 722. Further, output from torque estimator 722 may be applied in closed loop speed and/or torque control routines to control torque of the electric machine in block 716. For example, if a drive demands 200 Newton-meters (Nm) output torque from the inverter and motor at block 716, but torque estimator indicates that torque output of the electric machine is 202 Nm, electric current supplied to the electric machine of block 716 may be reduced to reduce estimated electric machine torque to 200 Nm.

Thus, the methods described herein provide for a method for estimating torque output of an electric vehicle propulsion source, comprising: generating a first polynomial for a first group of speeds of the electric vehicle propulsion source, where output of the first polynomial provides a torque estimate for the electric vehicle propulsion source; generating a second polynomial for a second group of speeds of the electric vehicle propulsion source, where output of the second polynomial provides a torque estimate for the electric vehicle propulsion source; and operating a vehicle in response to the torque estimate for the electric vehicle propulsion source. In a first example, the method includes where the first polynomial corresponds to a first speed range of the electric vehicle propulsion source. In a second example that may include the first example, the method includes where the second polynomial corresponds to a second speed range of the electric vehicle propulsion source, the second speed range greater than the first speed range. In a third example that may include one or both of the first and second examples, the method includes where the first polynomial receives electric machine speed and inverter DC input current as inputs. In a fourth example that may include one or more of the first through third examples, the method includes where the second polynomial receives electric machine speed and inverter DC input current as inputs. In a fifth example that may include one or more of the first through fourth examples, the method includes where the torque estimate includes compensation for inverter losses. In a sixth example that may include one or more of the first through fifth examples, the method includes where operating the vehicle includes adjusting torque output of the electric vehicle propulsion source. In a seventh example that may include one or more of the first through sixth examples, the method includes where operating the vehicle includes opening a contactor that selectively supplies electric power to the electric vehicle propulsion source.

The methods also provides for a method for estimating torque output of an electric vehicle propulsion source, comprising: generating a first linear curve for a first group of speeds of the electric vehicle propulsion source, where output of the first linear curve provides a torque estimate for the electric vehicle propulsion source; generating a second linear curve for a second group of speeds of the electric vehicle propulsion source, where output of the second linear curve is a torque estimate for the electric vehicle propulsion source; and operating a vehicle in response to the torque estimate for the electric vehicle propulsion source. In a first example, the method includes where the first linear curve is based on DC current flow into an inverter. In a second example that may include the first example, the method includes where the second linear curve is based on DC current flow into an inverter. In a third example that may include one or both of the first and second examples, the method includes where the second linear curve is further based on take-over point. In a fourth example that may include one or both of the first through third examples, the method includes where the second linear curve is further based on a speed of the electric vehicle propulsion source.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to electric vehicles and hybrid vehicles including induction and synchronous electric machines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for estimating torque output of an electric vehicle propulsion source, comprising:
generating a first polynomial for a first group of speeds of the electric vehicle propulsion source, where output of the first polynomial provides a torque estimate for the electric vehicle propulsion source;
generating a second polynomial for a second group of speeds of the electric vehicle propulsion source, where output of the second polynomial provides the torque estimate for the electric vehicle propulsion source; and
operating a vehicle in response to the torque estimate for the electric vehicle propulsion source.

2. The method of claim 1, where the first polynomial corresponds to a first speed range of the electric vehicle propulsion source.

3. The method of claim 2, where the second polynomial corresponds to a second speed range of the electric vehicle propulsion source, the second speed range greater than the first speed range.

4. The method of claim 1, where the first polynomial receives electric machine speed and inverter DC input current as inputs.

5. The method of claim 1, where the second polynomial receives electric machine speed and inverter DC input current as inputs.

6. The method of claim 5, where the torque estimate includes compensation for inverter losses.

7. The method of claim 1, where operating the vehicle includes adjusting torque output of the electric vehicle propulsion source.

8. The method of claim 1, where operating the vehicle includes opening a contactor that selectively supplies electric power to the electric vehicle propulsion source.

9. A vehicle system, comprising:
an electric energy storage device;
an electric machine configured to propel a vehicle;
an inverter configured to supply alternating current to the electric machine;
a contactor arranged in series between the electric energy storage device and the inverter; and
a controller including executable instructions stored in non-transitory memory that cause the controller to selectively open the contactor in response to an estimate of torque output of the electric machine, where the estimate of torque output is based on interpolating between two linear curves or interpolating between output of two polynomials.

10. The vehicle system of claim 9, where a first polynomial of the two polynomials corresponds to a first speed range of the electric machine.

11. The vehicle system of claim 10, where a second polynomial of the two polynomials corresponds to a second speed range of the electric machine, the second speed range greater than the first speed range.

12. The vehicle system of claim 11, where the first polynomial receives electric machine speed and inverter input current as inputs.

13. The vehicle system of claim 9, where a first curve of the two linear curves is based on a DC current flow into the inverter.

14. The vehicle system of claim 13, where a second curve of the two linear curves is based on a take-over point.

15. The vehicle system of claim 14, where the second curve is further based on DC current flow into the inverter.

16. A method for estimating torque output of an electric vehicle propulsion source, comprising:
generating a first linear curve for a first group of speeds of the electric vehicle propulsion source, where output of the first linear curve provides a torque estimate for the electric vehicle propulsion source;
generating a second linear curve for a second group of speeds of the electric vehicle propulsion source, where output of the second linear curve is the torque estimate for the electric vehicle propulsion source; and
operating a vehicle in response to the torque estimate for the electric vehicle propulsion source.

17. The method of claim 16, where the first linear curve is based on DC current flow into an inverter.

18. The method of claim 17, where the second linear curve is based on DC current flow into the inverter.

19. The method of claim 18, where the second linear curve is further based on take-over point.

20. The method of claim 16, where the second linear curve is further based on a speed of the electric vehicle propulsion source.
